(19) United States
(12) Patent Application Publication
(10) Pub. No.: US 2008/0084991 A1
(43) Pub. Date: Apr. 10, 2008

(54) Automatic switch-dialing system and method

(75) Inventors: Chih-Hsin Chuang, Taipei City (TW); Rong-Chin Yang, Taipei City (TW)

Correspondence Address: RABIN & Berdo, PC, 1101 14TH STREET, NW, SUITE 500, WASHINGTON, DC, 20005, US

(73) Assignee: INVENTEC MULTIMEDIA & TELECOM CORPORATION, Taipei City (TW)

(21) Appl. No.: 11/543,097

(22) Filed: Oct. 5, 2006

(51) Int. Cl. H04M 1/00

(52) U.S. Cl. 379/359

(57) ABSTRACT

An automatic switch-dialing system and method are provided, that can be applied on a telephone set having both of the Public Switched Telephone Network (PSTN) and the Voice over Internet Protocol (VOIP) dialing capabilities. During dialing out a phone call, the prefix code and the phone number length of the dialed phone number are compared with those stored in a preset routing table, thus determining the dialing mode of the dialed phone call. As such eliminating the inconvenience of manual setting for the user, and realizing the optimized balance between saving telephone expenses and achieving better communication quality.

### BACKGROUND

1. Field of Invention

The present invention relates to a switchable dialing system and method. More particularly, the present invention relates to an automatic switch-dialing system and method by making use of a routing table.

2. Related Art

In general, the Voice Over Internet Protocol (VOIP) refers to a telephone service conducted through Internet. Usually, the users of ordinary household or enterprise are capable of making phone calls through wide-band network without having to change their usual dialing habits and procedures just by making use of a VOIP Gateway additionally installed at the user's end. Nowadays, the Public Switched Telephone Network (PSTN) is the most popular and widely utilized public communication network, and presently the circuit switching of international phone calls is realized through this kind of network.

Circuit Switching usually means the actions required to connect the communication route between two points or among multiple points by making use of Private Branch Exchange (PBX). In other words, during a communication, such as route is dedicated to a specific user only. Therefore, no matter the user is talking or keeping silent on the phone, the user is being continuously charged by phone company. In addition, the monopoly of the telephone companies at both calling and receiving parties also contributes to the high cost of telephone call communications.

After being compressed into data packets through the VOIP, the respective voice signals are sent from the calling end to the receiving end through a network. As such, the voice transmission-related telecommunication application service is provided through the freedom oriented Internet. The application of network has the benefit of providing the real-time voice communication service that may reach various parts of the world, thus the users no longer have to conduct long distance phone conversation through the conventional PSTN. In addition, distortion and crosstalk occur in the transmission process can be eliminated or at least be reduced significantly, and the modifications required can be made, so that the original voice may authentically be reproduced. As such, through the application of the compression technology, the bandwidth required by VOIP can be reduced, thus realizing the benefit of effectively reducing the communication cost and achieving the full utilization of network band width.

Due to the rapid development of VOIP applications, the manufacturers in the communication industry have started to produce and provide the VOIP related hardware, such as the Terminal Adapter (TA) or VOIP Gateway, so that the ordinary household telephone set may be connected directly to such kind of hardware equipment. As such, the user may enjoy the VOIP service at low cost without having to make any changes to the utilization of PSTN, thus ensuring the conduction of phone conversation in case of emergency or blackout. In addition, the switching of the phone communication can be done manually in case of network congestion or in the condition that the calling party and the receiving party belong to different service providers, thus realizing phone communication of better quality.

Though the VOIP and PSTN may be utilized-by the user to achieve the optimized switch-dialing, however, for the people often making domestic or international phone calls, usually quite a few switching actions are required. In the design of certain phone sets, a special key thereon must be pressed to realize switching. Or furthermore, a set of verification numbers must first be entered, thus causing quite a lot of inconvenience for the user. Therefore, the design of a better and more convenient dialing and switching method is presently a most urgent task in this field.

### SUMMARY OF THE INVENTION

In view of the above-mentioned drawbacks and shortcomings of the prior art, the object of the present invention is to provide an automatic switch-dialing system and method, so that the telephone calls can be sent out through automatically switching between VOIP module and PSTN module based on the destination phone number input by the user, hereby eliminating the inconvenience of manual switching for the user, and achieving the result of cost-saving.

Therefore, to achieve the above-mentioned purpose, the present invention provides an automatic switch-dialing system and method. In addition to the two dialing modules of VOIP module and TSPN module, it further includes:

an input module, used to receive the destination phone number or establish the settings of a routing table.

a routing table, used to store a plurality sets of switch-dialing preset condition values set by the user, including the prefix setting condition, the minimum length of destination phone number, and the maximum length of destination phone number;

a switching module, used to determine what kind of dialing mode to be taken based on the destination phone number input by the user and the switch-dialing preset condition values in the routing table; and

a connection module, used to connect to VOIP and PSTN, and receive and transmit the voice signal data.

Moreover, to achieve the above-mentioned purpose and advantage of the present invention, the present invention discloses an automatic switch-dialing method, including the following steps:

Firstly, receive the destination phone number input by the user. Next, obtain the currently preset dialing mode. Then, in case that the currently preset dialing mode is VOIP mode, then determine if the phone call dialing mode of destination phone number needs to be changed and switched according to the routing table. Subsequently, if the answer to question is affirmative, switching to PSTN mode to proceed with the dialing required. Likewise, in case that the currently preset dialing mode is PSTN mode, and if it is determined according to the routing table that this phone call of the destination phone number must utilize VOIP to achieve cost-saving, then switch to the VOIP mode to proceed with the dialing of the phone. Finally, the connection module is used to make the connection for phone communication by making use of VOIP or TPSN.

Moreover, the present invention further provides a method for the user to establish a routing table, so that the setup of the routing table can be more flexible. Firstly, receive the settings input by the user for establishing a routing table from input device. Next, prompt the messages in the data fields to be set by the user. Then, receive the setting values input into the fields by the user. Subsequently, determine if the user has finished input settings. Finally, if it is determined that the user has finished the input settings, then proceed with the update of the setting values of the various fields stored in the routing table.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the invention, and wherein:

FIG. 1 is a schematic diagram of the system structure of an automatic switch-dialing system according to an embodiment of the present invention;

FIG. 2 is a schematic diagram of a routing table according to one embodiment of the present invention;

FIG. 3 is a flowchart of an automatic switch-dialing method according to one embodiment of the present invention; and

FIG. 4 is a flowchart of the method for establishing a routing table according to one embodiment of the present invention.

### DETAILED DESCRIPTION OF THE INVENTION

The purpose, construction, features, and functions of the invention can be appreciated and understood more thoroughly through the following detailed description with reference to the attached drawings.

The present invention discloses an automatic switch-dialing system and method. In the following description, various specific details are described to provide a through understanding of the invention. However, for the people familiar with the technology in this field, the invention can be implemented without these specific details. Or alternative elements or methods can be utilized to realize the invention. In other circumstances, the well-known methods, procedures, components and circuits are not described in particular detail, so as not to unnecessarily obscure the essence of the invention.

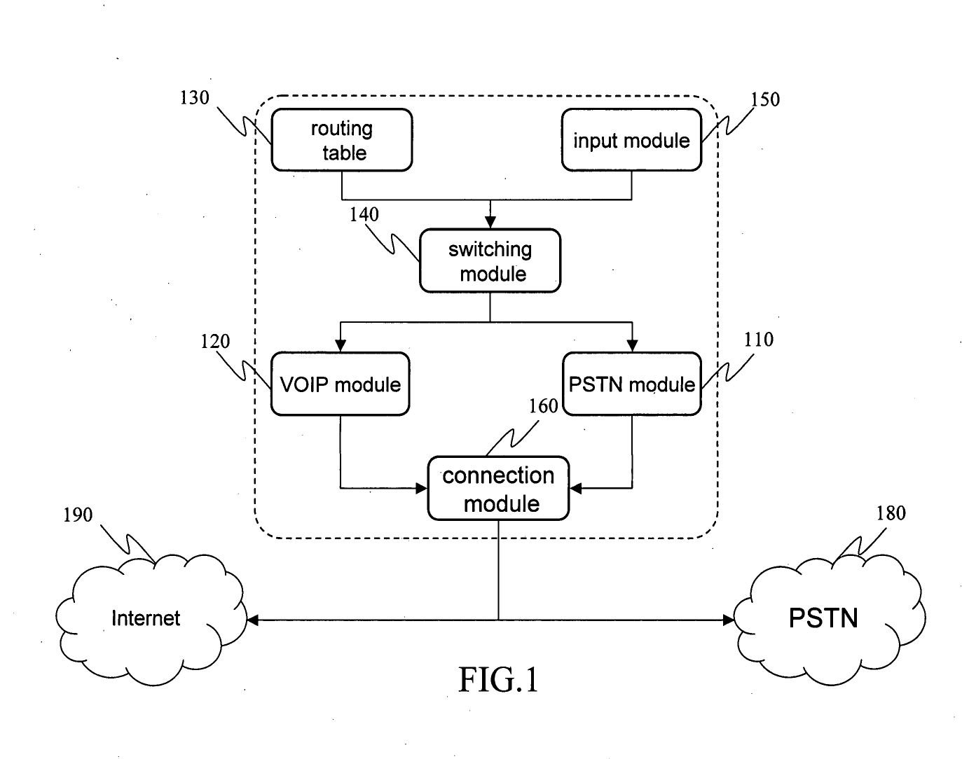

Firstly, refer to FIG. 1 for a schematic diagram of the system structure of an automatic switch-dialing system according to one embodiment of the present invention, including:

An input module 150, herein referred to as a physical device, such as a keyboard, a joystick, press keys, a remote controller, or a touch screen, that can be used by the user as an input device, and to receive the signals input by the user, for example, the destination phone numbers input by the user, the settings input by the user for establishing a routing table 130, or a plurality sets of switch-dialing preset condition values set and input by the user.

A switching module 140 is connected to a VOIP module 120 and a PSTN module 110 set and initialized by making use of the Session Initiation Protocol (SIP). In this connection, the destination phone number input by the user and the switch-dialing preset condition values in the routing table 130 are utilized to determine which dialing mode is used to proceed with the dialing. In case that, if the determined result is different from that of the currently preset dialing mode, then proceed with the switching of the dialing mode, In actual process of communication, for VOIP module 120, the voice signals are transmitted in the form of digital signals through IP network by means of VOIP communication protocol; while for PSTN module 110, the voice signals are transmitted in the form of analog signals.

A connection module 160 is used to receive and transmit voice signal data, including: the Foreign Exchange Office (FOX) port, connected to Private Branch Exchange (PBX) to carry on the phone communication in the conventional TSPN manner; the Foreign Exchange Station (FXS) port is connected to the ordinary analog telephone set or facsimile machine, and is used to transfer telephone calls or process facsimile; and Internet Protocol (IP)/Wireless Foreign Exchange Office (WFXO) port, used to receive the calls from the user of wired/wireless network.

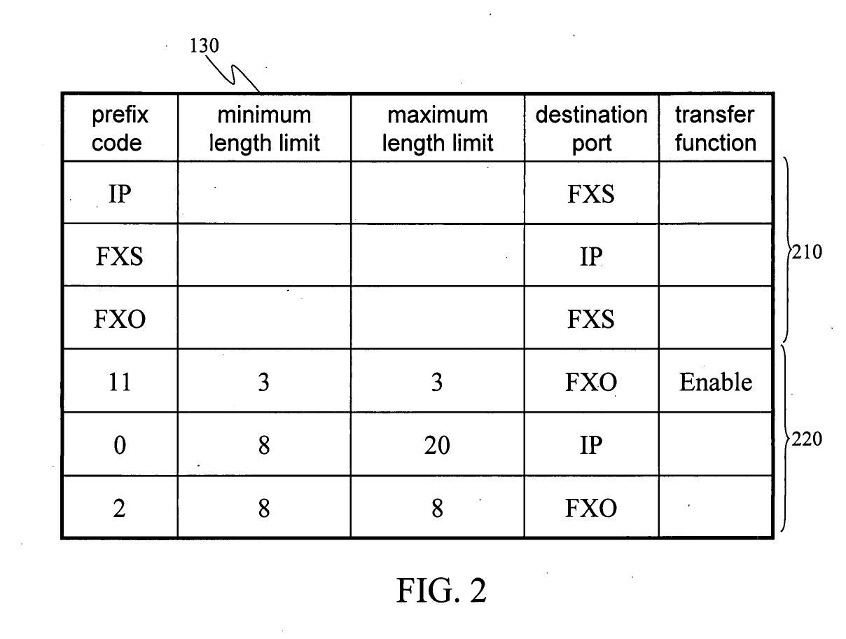

A routing table 130 is used to store a plurality sets of switch-dialing preset condition values set by the user, is as shown in FIG. 2, that is a schematic diagram of a routing table 130 according to one embodiment of the present invention, including: a “prefix code” field, used to record the type of origin and the type of the prefix code; a “minimum length limit” field, used to record the minimum length limitation of the destination phone number; a “maximum length limit” field, used to record the maximum length limitation of the destination phone number; a “destination port” field, used to record the type of communication port utilized in proceeding with data transmission/reception; and a “transfer function” field, used to record and specify other types of communication ports that can be used to transmit/receive data when the originally set destination port is busy.

In addition, the data setting portions include: a preset routing area 210, used to select the preset routing according to the type of origin, when there is no matching routing setting; a setting routing area 220, used to record a plurality sets of switch-dialing preset condition values set by the user. In this connection, row 1 of this setting routing area 220 is taken as an example and explained as follows: the prefix code “11” means that the first two codes of the destination phone number received from the input module 150 input by the user is “11”; while the minimum length limit and maximum length limit of 3 means that the destination phone number contains only three codes (for example: 911). As such, when the user dials 911, then the conventional PSTN module 110 is utilized to proceed with the necessary connection, and in this case, if FXO port is presently occupied and busy, that means that other user is currently using FXO port and making the phone conversation, and in this case, if the content of “transfer function” field is set at “enable”, then other idle communication ports such as IP port may be utilized immediately.

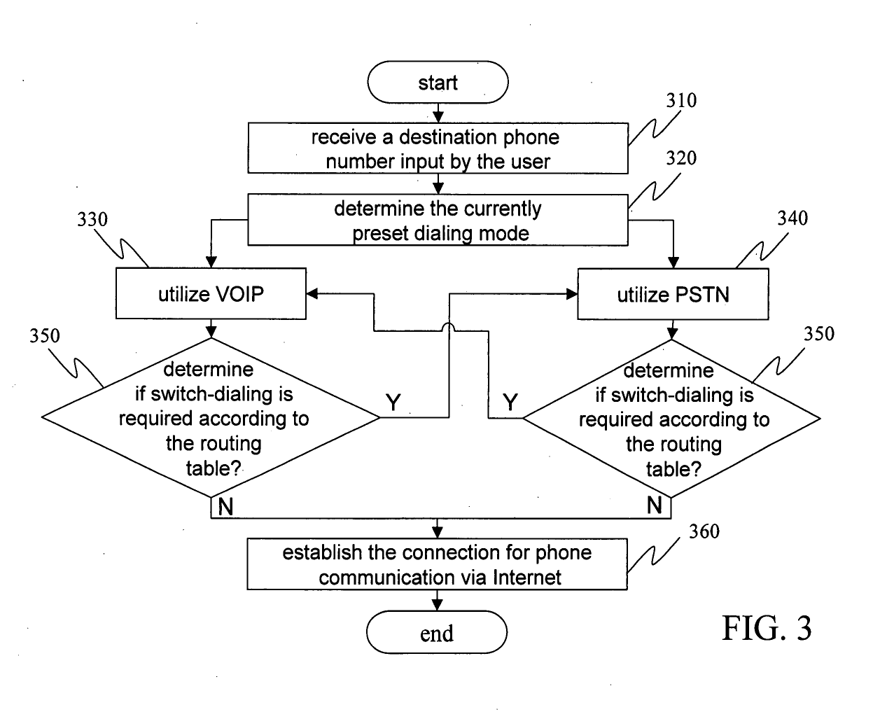

Then, refer to FIG.3 for a flowchart of an automatic switch-dialing method according to one embodiment of the present invention, including the following steps:

Firstly, receive a destination phone number input by the user (step 310), in this case, suppose that the phone number input by the user and received at the input module 150 is 0912345678. Next, determine the currently preset dialing mode (step 320), in this case, the afore-mentioned dialing 911 without line-busy instance is taken as an example, such that the preset FXO port is utilized, namely, the PSTN 180 is utilized (step 340). Therefore, since it matches the setting in row 2 of setting routing area according to the setting conditions as shown in FIG. 2, so the destination port in use is set as the IP port. Then, determine if switch-dialing is required for dialing the phone call of the destination phone number according to the routing table 130 (step 350), and if the answer to question is positive, then the phone call connection is switched to the VOIP module 120 via the switching module 140 to proceed with the dialing. Likewise, in the case the afore-mentioned dialing 911 having line-busy instance is taken as an example, then it is preset to use IP port, namely, the VOIP (step 330). Then, determine if switch-dialing is required for dialing the phone call of the destination phone number according to the routing table 130 (step 350), and if the answer to question is negative, then at this time the switching module 140 does not have to take any actions Finally, the connection module 160 is used to establish a connection for phone communication via Internet 190 (step 360).

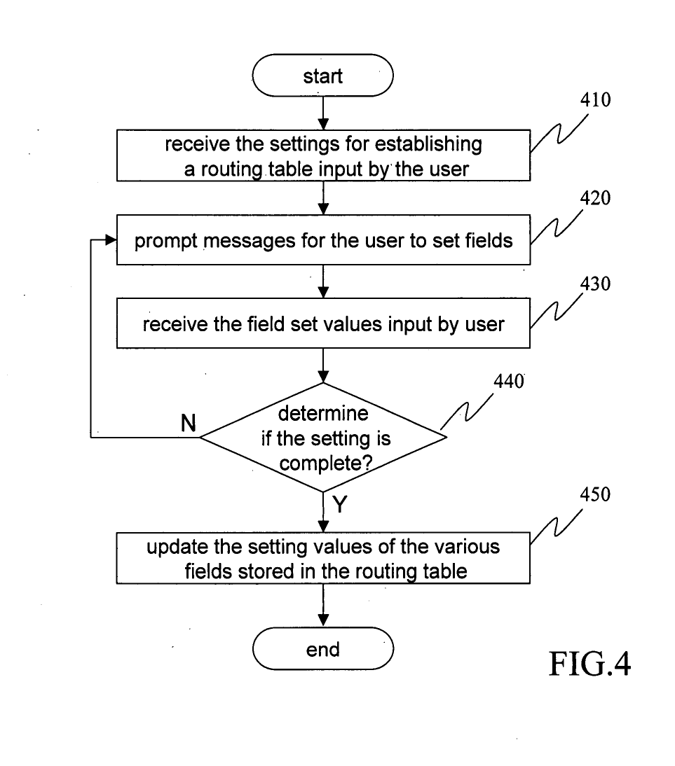

Subsequently, in order that the routing table 130 may be utilized in a manner compatible with the habit of user making a phone call, refer to FIG. 4 for a flowchart of the method for establishing a routing table 130 according to one embodiment of the present invention. Through the application of this method, the user may set the switch-dialing setting conditions in compatible with his ordinary way of dialing and making a phone call, so that the setting of routing table 130 can be more flexible. Firstly, receive the settings for establishing a routing table 130 input by the user from the input module 150 (step 410), to proceed with the process of writing in the routing table 130. Next, prompt messages for the user to set fields (step 420), for example, “please enter the prefix code” through voice or screen display. In case that the local phone calls made by the user usually is dialed and connected through the conventional PSTN to achieve low cost and better quality phone communication. As such, upon entering 2 via the input module 150, a specific key (for example, the non-numeric press key “*”, “#” . . . etc.) is pressed to indicate the completion of setting this field (step 430). Then, continue the message prompting for reminding the user to input the minimum length limit, the maximum length limit, and the destination port.

Upon the completion of entering the switch-dialing setting conditions, a specific key is pressed similarly to indicate the completion of the setting of the switch-dialing setting conditions, so that the input module 150 is informed to know the completion of setting upon receiving the input signal generated by such a specific key (step 440). Finally, update the setting values of the various fields stored in the routing table 130 (step 450), as shown in the switch-dialing setting conditions in row 3 of the setting routing area 220 of FIG. 2. According to the similar design concept, two additional time fields used for the time starting and a time terminating may be added to the routing table 130, so that the switch-dialing of phone communication may be realized according to the routing table incorporating such time conditional values.

In conclusion, through the application of the present invention, the users are provided with different dialing modes to proceed with phone dialing. Furthermore, through the determination of the destination phone number input by the user, the automatic switch-dialing utilizing VOIP module or TSPN module can be achieved, thus eliminating the inconvenience of manual switching for the user, and realizing the optimized results of reduced operation cost and better communication quality.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An automatic switch-dialing system, provided with two or more dialing modes, comprising:
an input module, used to receive a destination phone number and at least one switch-dialing preset condition values input by a user;
a routing table, used to store the switch-dialing preset condition values set by the user;
a switching module, used to determine a dialing mode according to the switch-dialing preset condition value s of the routing table; and
a connection module, used to proceed with a connection for phone communication through a destination port corresponding to the dialing mode.

2. The automatic switch-dialing system as claimed in claim 1, wherein the routing table includes a prefix code field and a destination port field.

3. The automatic switch-dialing system as claimed in claim 2, wherein the routing table further includes a minimum length limit field.

4. The automatic switch-dialing system as claimed in claim 2, wherein the routing table further includes a maximum length limit field.

5. The automatic switch-dialing system as claimed in claim 2, wherein the routing table further includes a transfer function field.

6. The automatic switch-dialing system as claimed in claim 2, wherein the routing table further includes a time starting field and a time terminating field.

7. The automatic switch-dialing system as claimed in claim 1, wherein the dialing modes are the Voice Over Internet Protocol (VOIP) mode and the Public Switched Telephone Network (PSTN) mode.

8. The automatic switch-dialing system as claimed in claim 1, wherein the destination port is a Foreign Exchange Office (FXO) port.

9. The automatic switch-dialing system as claimed in claim 1, wherein the destination port is a Foreign Exchange Station (FXS) port.

10. The automatic switch-dialing system as claimed in claim 1, wherein the destination port is an Internet Protocol (IP) port.

11. The automatic switch-dialing system as claimed in claim 1, wherein the destination port is a Wireless Foreign Exchange Office (WFXO) port.

12. An automatic switch-dialing method, comprising the following steps:
receiving a destination phone number input by a user;
obtaining a preset dialing mode;
determining if the dialing mode of the destination phone number is compatible with the preset dialing mode, based on at least one switch-dialing setting condition values stored in a routing table; and
switching the dialing mode of the destination phone number to the dialing mode corresponding to that as specified in the routing table in proceeding with dialing and connecting when the two dialing modes are not compatible.

13. The automatic switch-dialing method as claimed in claim 12, wherein the routing table includes a prefix code field and a destination port field.

14. The automatic switch-dialing method as claimed in claim 12, wherein the routing table further includes a minimum length limit field.

15. The automatic switch-dialing method as claimed in claim 12, wherein the routing table further includes a maximum length limit field.

16. The automatic switch-dialing method as claimed in claim 15, wherein the routing table further includes a transfer function field.

17. The automatic switch-dialing method as claimed in claim 15, wherein the routing table further includes a time starting field and a time terminating field.

18. The automatic switch-dialing method as claimed in claim 12, wherein the dialing modes are the Voice over Internet Protocol (VOIP) mode and the Public Switched Telephone Network (PSTN) mode.

19. The automatic switch-dialing method as claimed in claim 12, wherein the routing table establishing method includes the following steps:
receiving settings input by the user for establishing the routing table;
receiving a plurality of field setting values input by the user; and
updating the respective field setting values stored in the routing table.
